(19) United States
(12) Patent Application Publication
(10) Pub. No.: US 2005/0160076 A1
(43) Pub. Date: Jul. 21, 2005

(54) Method and apparatus for referring to database integration, and computer product

(75) Inventor: Yasuhiko Kanemasa, Kawasaki (JP)

Correspondence Address: Patrick G. Burns, Esq.;GREER, BURNS & CRAIN, LTD., Suite 2500, 300 South Wacker Dr., Chicago, IL, 60606, US

(73) Assignee: FUJITSU LIMITED

(21) Appl. No.: 10/876,917

(22) Filed: Jun. 25, 2004

(30) Foreign Application Priority Data
Jan. 20, 2004 (JP) 2004-012306

(51) Int. Cl. G06F 17/30

(52) U.S. Cl. 707/2

(57) ABSTRACT

When referring to database integration, integration metadata is stored. The integration metadata defines a format of a tagged document used for outputting a result of a query for data reference to a plurality of databases, a relation between each element in the tagged document and each element in each database, and a relation between the elements in each database. When a query is received in a format of the tagged document, the integration metadata is referred to and queries are made to various databases to acquire data. Finally a result of the queries is generated in the format of the tagged document.

### BACKGROUND OF THE INVENTION

1) Field of the Invention

The present invention relates to a technology for referring to database integration by receiving a query about data reference with respect to a plurality of databases, and acquires data related with the query from various databases.

2) Description of the Related Art

Sometimes different databases are located in different machines or different environments and relational data are dispersed over the databases. In such cases, a new data warehouse is constructed and all data is transferred to the data warehouse, so that the data can be referred to as an integrated single database.

However, there is a problem in this method in that copying of data from the original database to the data warehouse introduces a time lag, and therefore, data in the original database cannot be referred to in real time. Moreover, there is additional cost and time to construct the data warehouse. Therefore, if a business situation changes over a short term and a request for integration of databases changes accordingly, the above method cannot cope with the changes promptly.

As a solution to this problem, a technique called “query-based database integration” has been disclosed. The technique uses the data grid technology, so that pieces of data dispersed over a plurality of databases (DBs) remain in the individual DBs, and are not physically gathered. When a user requests for reference to integrated data, a query is made to each DB in real time to acquire necessary pieces of data, which are integrated and then returned to the user. For example, “IBM DB2 Information Integrator V8.1”, [online], [Searched on Jan. 16, 2004] Internet <http://www-6.ibm.com/jp/Products/news/030522/gaiyo.html> and “OGSA-DAI”, [online], [Searched on Jan. 16, 2004] Internet <http://www.ogsadai.org/> disclose query-based database integration that accesses plural DBs of different types (which differ in manufacturer or data structure method) using the same access unit.

Because the query-based database integration acquires data over a network, the response time is slow, but practicality increases due to the recent fast networks. Excluding the performance problem, data located over plural DBs can be used as if present in a single DB. Apparently, the query-based database integration overcomes the time lag that occurs in case of a data warehouse and does not require modifying databases themselves. Thus, the query-based database integration can promptly cope with a request for database integration, which occurs due to changes in business situations.

The conventional database integration technology simply integrates the access units to databases and the data storage structure remains unchanged. However, users need to be aware of the original data storage structure while accessing data. That is, data stored in existing databases itself is simply acquired and displayed and users are actually provided with a view for every data accessed. Therefore, the users merely see tables that are dispersed over individual databases as if they were present in a single database, as exemplified in FIG. 26. This requires that the users should make a query while being conscious of the actual data dispersion. Thus, it is difficult to gather relational data from multiple databases and raises the following specific problems.

The difficulty to acquire data as in distributed databases exists even in the case when all the data is stored in a single database. However, in a single database, the pieces of data are stored based on a certain policy and are unified. In case of storing pieces of data over plural databases, such unification is lost, and making a query is more difficult.

When data are dispersed over plural databases, metadata of the databases are also present at separate locations and the form of the metadata varies. Consequently, making a query that conforms simultaneously to the storage structures of all the databases becomes even more difficult.

When data of the same kind are separately stored in a plurality of databases and data having one specific value is stored in one of the databases, it is necessary to query all the databases to retrieve data required. The more the number of databases, the more difficult it is to make a query.

As a solution, a function of combining views provided for the data accessed, into a single view (integration of data views) should be separately prepared in an upper-level application. The development of an upper-level application involves multiple steps, and hence it is still more difficult to modify the upper-level application to cope with recent frequent changes in business, such as company reorganization and business reconstruction.

### SUMMARY OF THE INVENTION

It is an object of the invention to at least solve the problems in the conventional technology.

An apparatus for referring to database integration according to one aspect of the present invention includes a storing unit that stores integration metadata which defines a format of a tagged document used for outputting a result of a query for data reference to a plurality of databases, a relation between each element in the tagged document and each element in each database, and a relation between the elements in each database; and a query processing unit that receives the query in a format of the tagged document, refers to the integration metadata in the storing unit and makes a query with respect to various databases to acquire data, and generates a result of the query in the format of the tagged document.

A method of referring to database integration according to another aspect of the present invention includes storing integration metadata, in which a format of a tagged document used for outputting a result of a query for data reference to a plurality of databases, a relation between each element in the tagged document and each element in each database, and a relation between the elements in each database are defined; and performing query processing that includes receiving the query in a format of the tagged document, referring to the integration metadata and making a query with respect to various databases to acquire data, and generating a result of the query in the format of the tagged document.

A computer program according to still another aspect of the present invention realizes the above method according to the present invention on a computer.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 illustrates features of a database integration referring system according to a first embodiment;

FIG. 2 illustrates the features of the database integration referring system;

FIG. 3 is a structural diagram of the database integration referring system;

FIG. 4 illustrates a structural example of information stored in each database;

FIG. 5 illustrates an example of mapping of integration metadata to Extensible Markup Language (XML);

FIG. 6 illustrates an example of a structure of virtual XML schema information;

FIGS. 7 to 10 illustrate an example of a structure of database information;

FIG. 11 illustrates an example of a structure of information about relationship between elements;

FIG. 12 illustrates details of an access process;

FIG. 13 is a flowchart of a query process according to the first embodiment;

FIG. 14 illustrates a specific example of the query process;

FIG. 15 illustrates an example of a first query to a handling item table;

FIG. 16 illustrates the first query to the handling item table and the query result obtained;

FIG. 17 illustrates an example of a query to an order form table and an item table;

FIG. 18 illustrates an example of a query to an item table;

FIG. 19 illustrates an example of a query to the handling item table;

FIG. 20 illustrates an example of a query to a stock table I;

FIG. 21 illustrates an example of a query to a stock table II;

FIG. 22 illustrates results of all queries in the example in the embodiment;

FIG. 23 illustrates a final result of the query in XML form;

FIG. 24 illustrates a computer system according to a second embodiment;

FIG. 25 is a block diagram of a main unit of the computer system; and

FIG. 26 illustrates a conventional technique of database integration.

### DETAILED DESCRIPTION

Exemplary embodiments of an apparatus, a method, and a computer program for referring to database integration according to the present invention are described in detail with reference to the accompanying drawings.

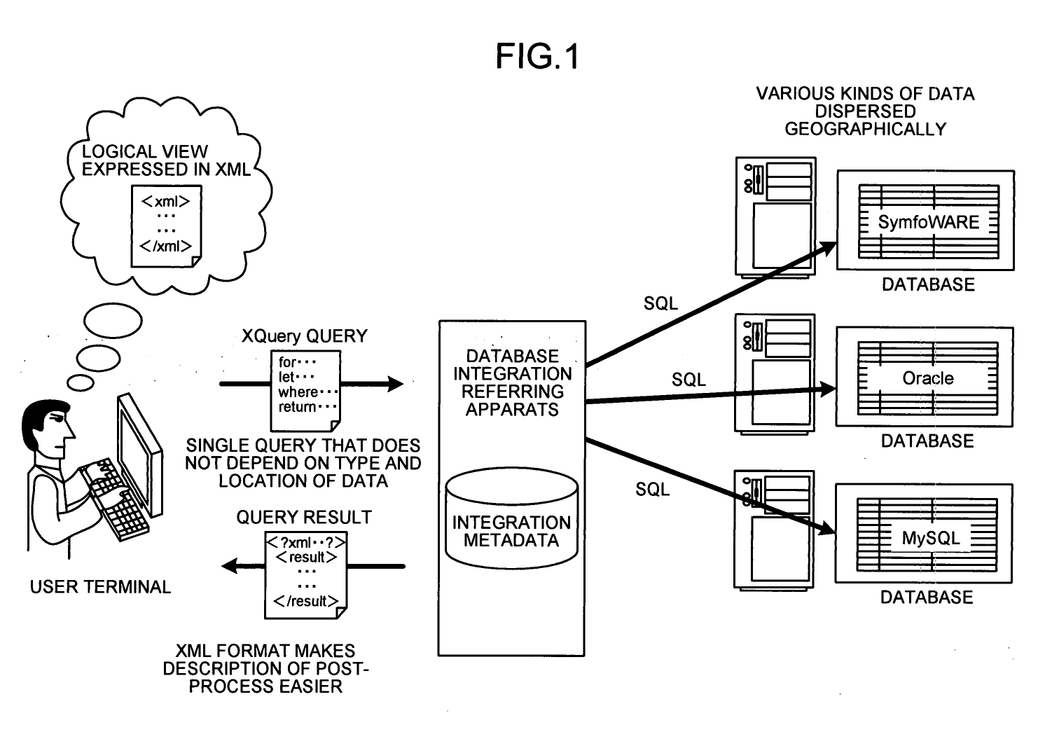

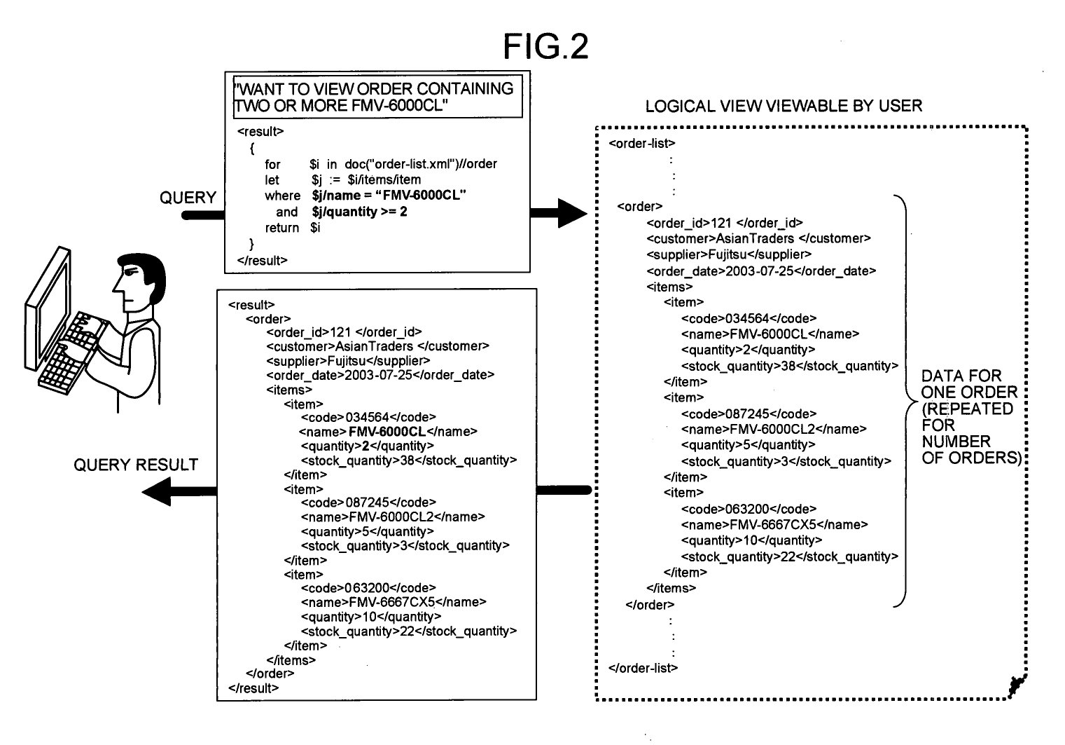

The summary and the features of a database integration referring system according to a first embodiment of the present invention are described with reference to FIGS. 1 and 2.

As shown in FIG. 1, the database integration referring system according to the first embodiment includes a database integration referring apparatus intervened between a user terminal and plural databases. The database integration referring apparatus receives a query from the user terminal about data reference with respect to a plurality of databases, acquires data related with the query from each database, and returns the result of the query to the user terminal.

The database integration referring apparatus in the system receives a query based on a tagged document (e.g., a query described in an XML query language, which is called XQuery), integrates pieces of data dispersed over plural databases using integration metadata and users can see the pieces of data as a single virtual tagged document (for example, an XML file)

More specifically, on the apparatus side, the database integration referring apparatus achieves integration of data views using “Globus Toolkit 3+OGSA-DAI”, which is a standardized data grid middleware. Moreover, “Globus Toolkit 3+OGSA-DAI” enables constructing an integrated query engine to provide data in an integrated relational DB in the form of an XML model, and handling dispersed pieces of data in the form of an XML file.

Therefore, the database integration referring system according to this embodiment can ensure real-time data accesses, significant reduction in the number of steps in developing an upper-level application, an integrated DB that has high flexibility and extensibility, and step-by-step structure of metadata.

That is, pieces of data dispersed over a plurality of existing databases remain in the DBs, instead of being physically gathered as in a data warehouse, and only necessary pieces of data are acquired when a query is made. Consequently, the user gets an integrated data view and real-time data access.

Pieces of data dispersed are integrated into an XML file in the embodiment. Therefore, it is possible to make an XQuery query as an XML file and acquire the result of the query in the form of XML. That is, an upper-level application can be provided with an integrated data view as an XML file, thus making it unnecessary to incorporate a data view integrating function in, the upper application. Thus, the steps for development of the upper application significantly reduce.

In addition, this embodiment does not integrate data in plural relational DBs in the form of a relational model, but provides a view of integrated relational DBs in the form of an XML file by performing a model conversion. The format of an XML file provides higher flexibility and extensibility than the relational model. In other words, as a data view integration according to this embodiment is XML-based, not only a retrieval system but also various application systems adapted to XML can easily be constructed on the system according to this embodiment. Consequently, database integration with higher flexibility and extensibility is possible.

Using integration metadata, this embodiment freely defines the type of virtual XML to be constructed from plural dispersed data. The definition is accomplished merely with information needed for a query. Therefore, it is not necessary to define all information from the beginning and can ensure step-by-step structure of integration metadata.

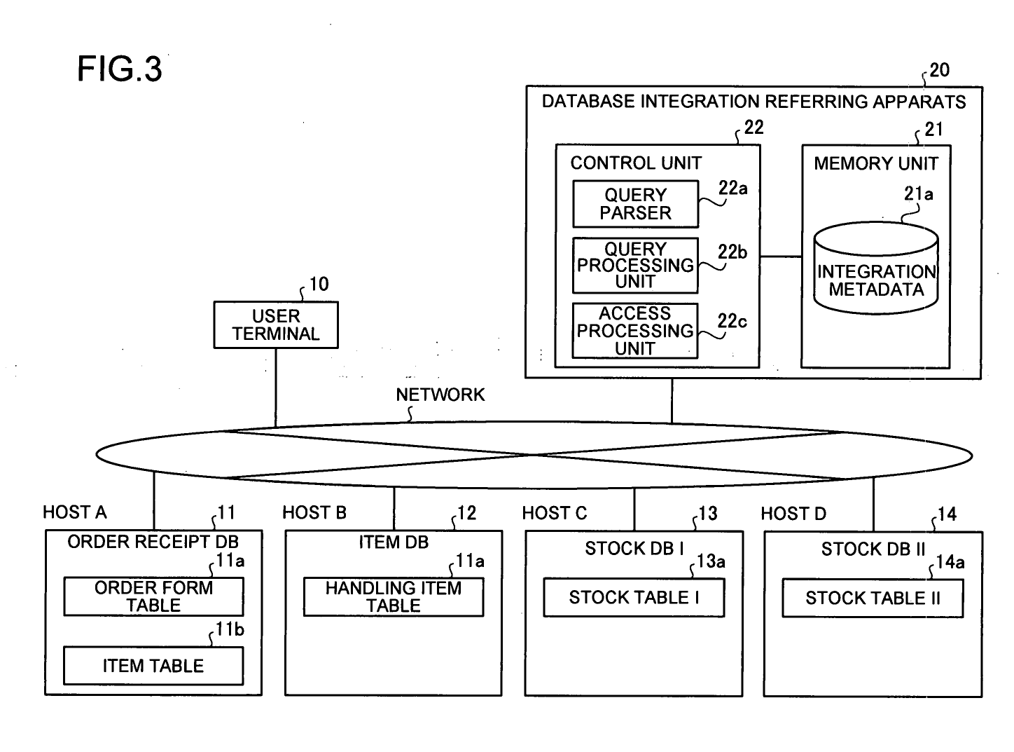

The general structure of the database integration referring system according to the first embodiment is discussed with reference to FIG. 3. FIG. 3 illustrates a general structure of the database integration referring system according to the first embodiment.

As shown FIG. 3, the database integration referring system includes a user terminal 10, a plurality of databases, and a database integration referring apparatus 20 connected to one another for communication over a network such as a local area network (LAN) or the Internet. The databases are an order receipt DB 11, an item DB 12, a stock DB I 13, and a stock DB II 14.

Each database is integrated by the first embodiment and is constructed by a known database apparatus, such as a relational database. In the first embodiment, pieces of data are dispersed over four databases, namely the order receipt DB 11, the item DB 12, the stock DB I 13, and the stock DB II 14.

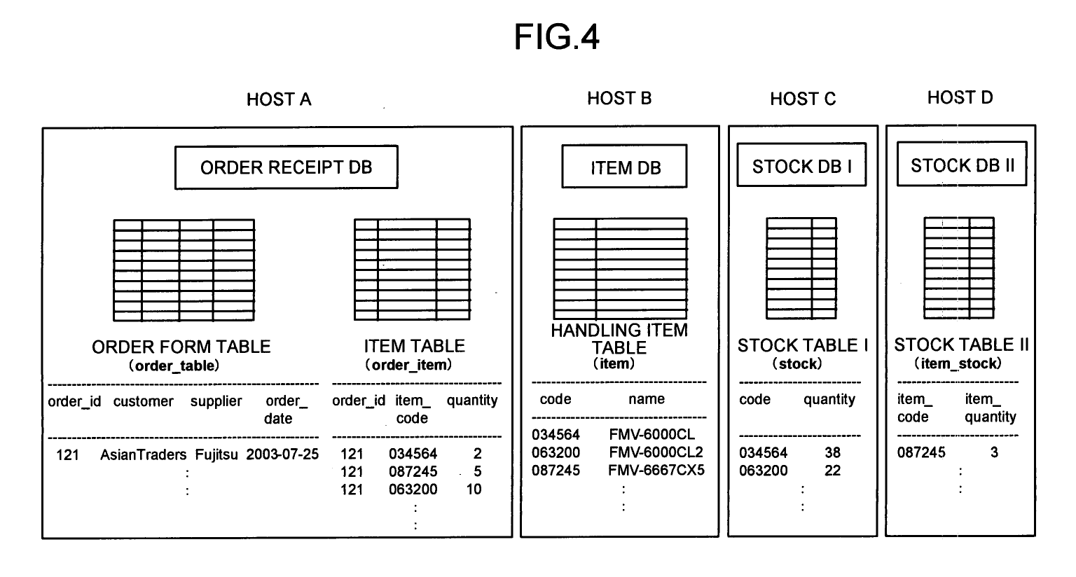

FIG. 4 illustrates a structural example of information stored in each database. The order receipt DB 11 stores information on orders received by a company and includes an order form table 11a that stores “order_id” (order ID), “customer” (customer name), “supplier” (supplier name), and “order_date” (date of order reception). Likewise, an item table 11b in the order receipt DB 11 stores “order_id” (order ID), “item_code” (item code), and “quantity” (the number of items ordered). One order form includes a plurality of items ordered, and hence, plural records in the item table 11b correspond to one record in the order form table 11a.

The item DB 12 stores items handled by the company and includes a handling item table 12a that stores “code” (item code), and “name” (the name of an item) for each handling item.

The stock DB 13 stores items in stock and includes a stock table I 13a that stores “code” (item code) and “quantity” (quantity in stock). Likewise, the stock DB 1114 stores items in stock. A stock table II 14a in the stock DB 1114 stores “item_code” (item code) and “item_quantity” (quantity in stock).

Although the items are merely described as item codes on the order form, it is better that item names are displayed when a person sees the order form. Therefore, a merit of the database integration referring system according to the first embodiment is that, using the handling item table 12a in the item DB 12, the item names corresponding to the item codes on an order form can be displayed for a user.

Another merit in using the database integration referring system according to the first embodiment is that, the quantity of an item in stock when the order is processed can be displayed in the order form. Note that to acquire the quantity of an item in stock from the stock DB, a query about the quantity of each item in stock should be made to both the stock DB I 13 and the stock DB II 14, because the quantity of the item in stock is stored in either the stock DB I 13 or the stock DB II 14. Apparently, there is a merit in using the database integration referring system according to the first embodiment when a user wants to put pieces of data about one order dispersed over the four databases into one collective data and refer to the collective data.

With reference to FIG. 3, the user terminal 10 is used by a user to acquire data from plural databases via the database integration referring apparatus 20, and may be an existing personal computer or work station, a personal digital assistant (PDA), or a mobile communication terminal, such as a cellular phone or a personal handyphone system (PHS).

As shown in FIGS. 1 and 2, the user terminal 10 accepts an XQuery query described in the XML query language, via a keyboard, a mouse or the like, sends the XQuery query to the database integration referring apparatus 20, receives a query result in XML format, and outputs the query result received, to a monitor or the like.

As shown in FIG. 2, the database integration referring system according to the first embodiment allows the user to see pieces of information about each order as a single piece of information included within an order tag (<order>) and all the orders are stored sequentially in a single XML file. This is merely a logical view and the substance of data lies only in each database. When the user, supposing that such a logical view exists, makes a query to the database integration referring apparatus 20, XML data for the related order is returned as the query result.

With reference to FIG. 3, the database integration referring apparatus 20 is a known server computer and processes a query for data reference that is received from the user terminal 10. The database integration referring apparatus 20 mainly receives an XQuery query from the user terminal 10, acquires data related to the query from each database and generates an XML query result, and sends the XML query result generated to the user terminal 10. The following gives a detailed description of the structure of the database integration referring apparatus 20 that executes the main features of the first embodiment.

The database integration referring apparatus 20 includes a memory unit 21, and a control unit 22 (see FIG. 3). The memory unit 21 stores data and programs needed for various processes executed by the control unit 22. The memory unit 21 stores integration metadata 21a in a repository manner as shown in the diagram.

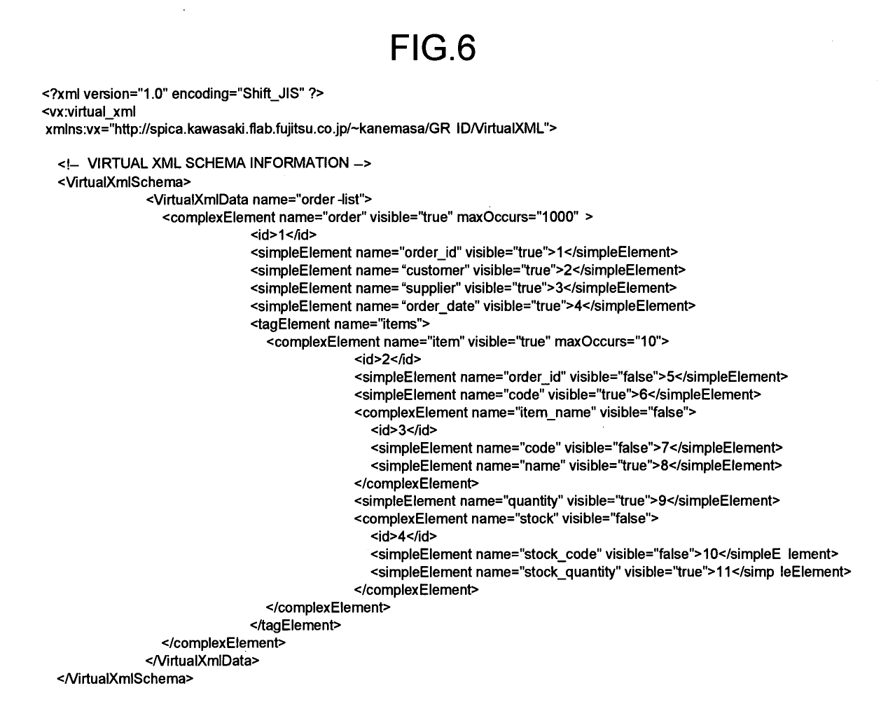

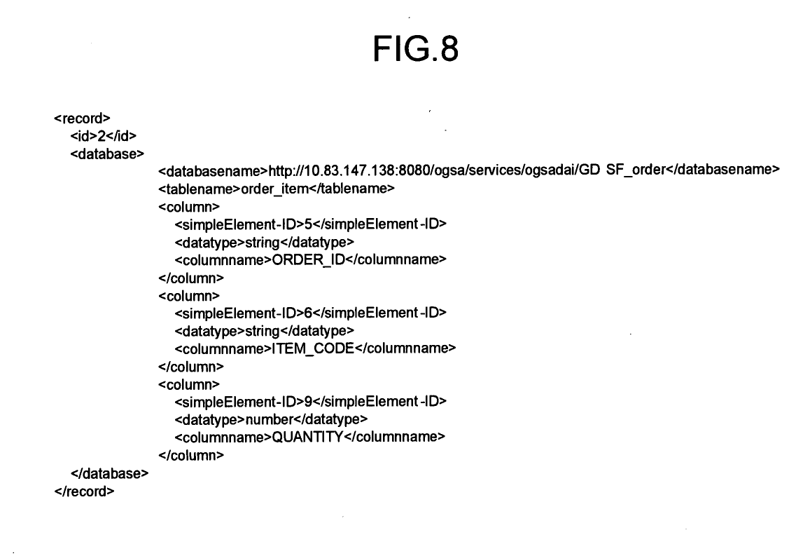

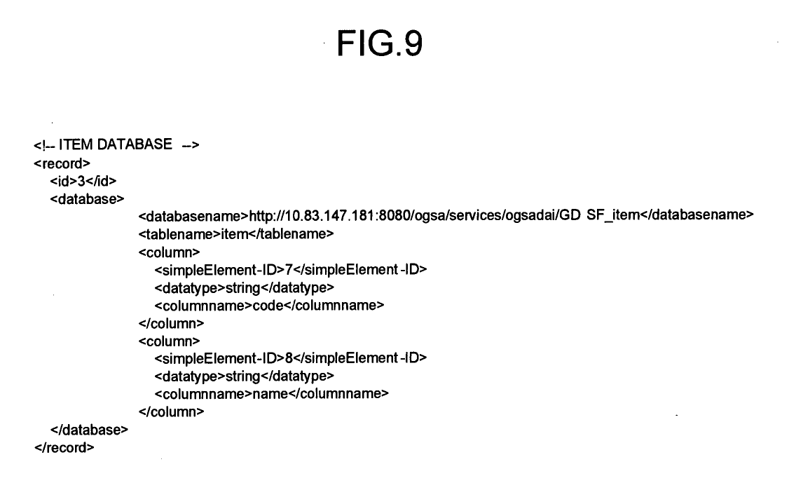

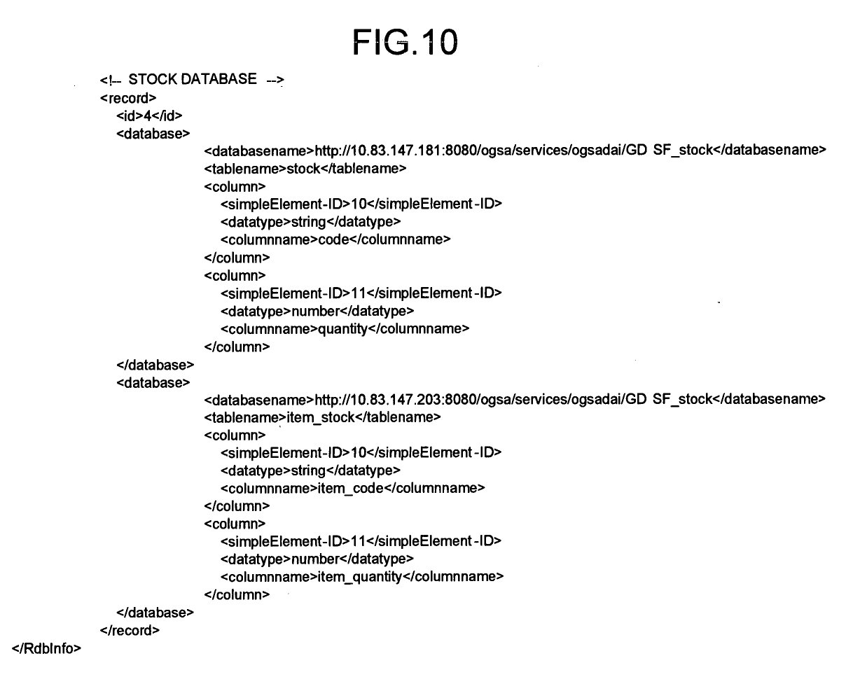

Information necessary for integration of various databases is defined in the integration metadata 21a. Specifically, as shown in FIGS. 6 to 11, the integration metadata 21a is constructed by describing virtual XML schema information, database information and information about relationship between elements.

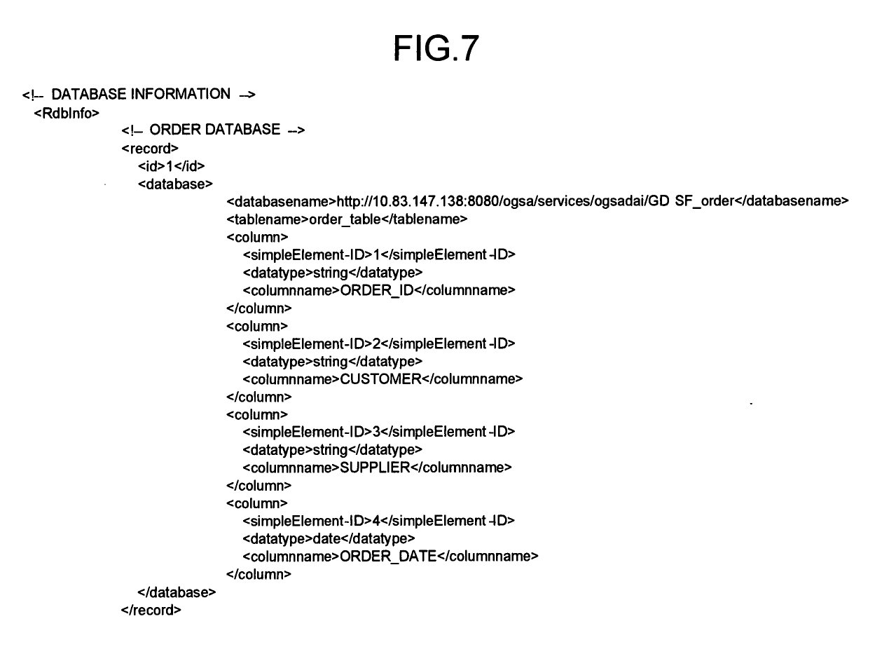

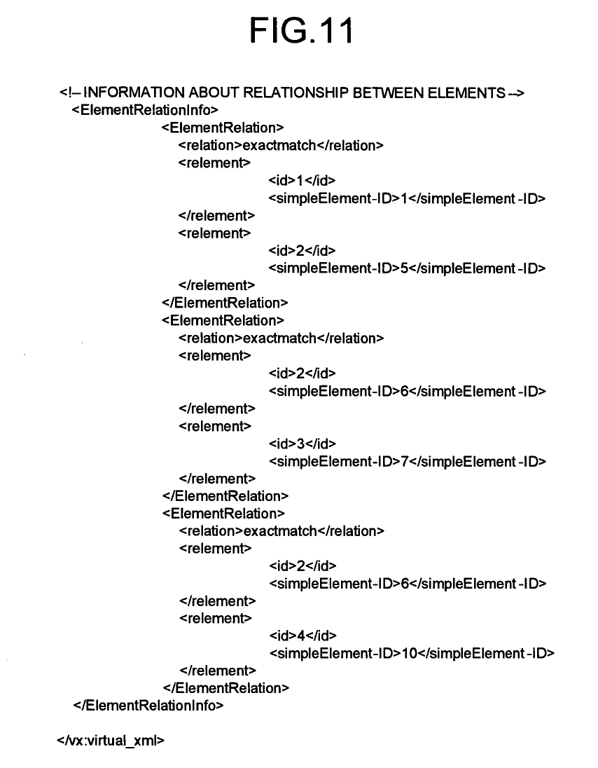

FIG. 6 illustrates an example of a structure of virtual XML schema information. The virtual XML schema information allows a user to see pieces of data that are dispersed over plural databases, as XML data. FIGS. 7 to 10 illustrate examples of database information. The database information indicates which element in which database corresponds to an element in the XML. As shown in FIG. 11, the information about relationship between elements indicates the corresponding table and the corresponding column of the table when different records of different tables are integrated in a single XML. The integration metadata shown in FIGS. 6 to 11 make up a single integration metadata-and are stored in a single XML file.

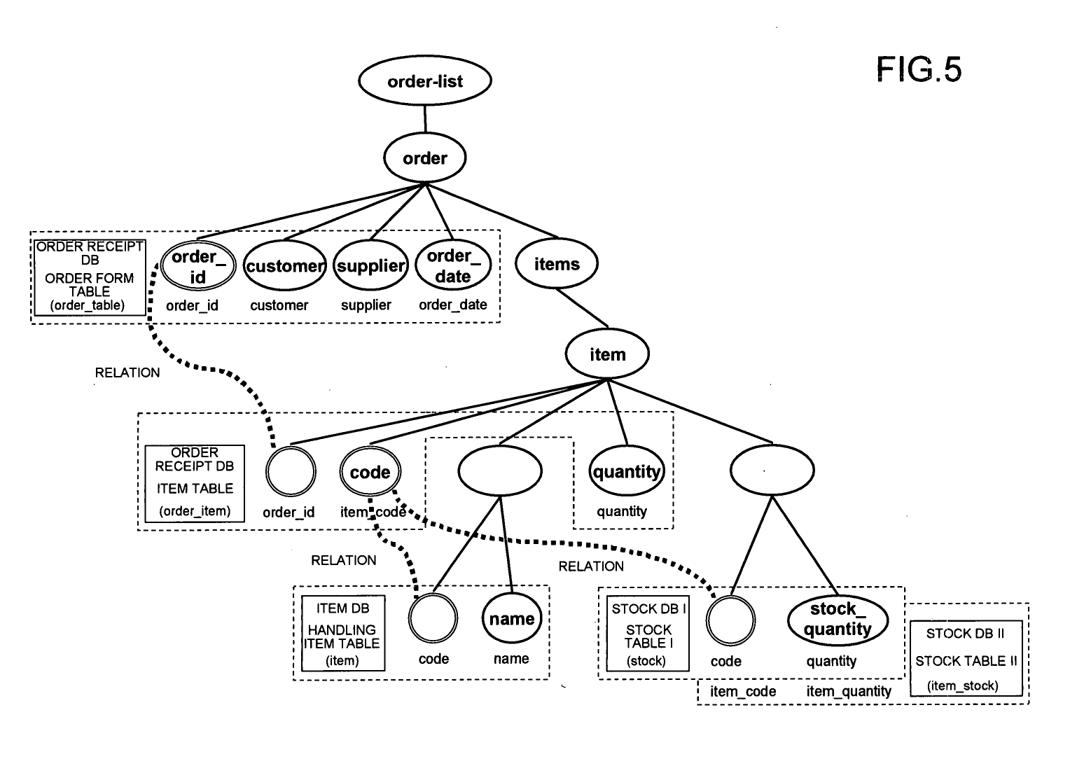

The integration metadata 21a is stored in the memory unit 21 beforehand, and is generated by a system administrator or the like by mapping. FIG. 5 illustrates an example of mapping of integration metadata to XML. In the example, data in the four databases shown in FIG. 4 are mapped into an XML tree structure. Information having the same contents as those shown in FIG. 5 is described in the integration metadata 21a in XML format, so that the user sees integrated data as XML data.

Rules of mapping data in a database into an XML tree structure are described next. (1) A user sees as if pieces of data dispersed over plural databases, which are integrated into single data, were present in a single XML file. (2) Pieces of data to be integrated in databases are mapped into XML elements, table by table. (3) XML elements corresponding to a table can be arranged hierarchically. (4) In one table, for those XML elements that are adjacent to each other in the upward and downward direction in the hierarchical structure, pieces of data should be related with one another in corresponding tables. That is, one column in each of corresponding tables should take the same value. (5) A plurality of tables in separate databases may be designated to a table corresponding to a single XML element. (6) A tag name of XML corresponding to a column in a database may be made different from the column name.

With reference to FIG. 3, the control unit 22 in the database integration referring apparatus 20 includes an internal memory (not shown) to store a control program such as an operating system (OS), a program that defines procedures of various kinds of processes and data necessary for the processes, and executes various processes based on the programs and the data. The control unit 22 further includes a query parser 22a, a query processing unit 22b, and an access processing unit 22c, as the components particularly closely related to the present invention.

The query parser 22a parses the syntax of the XQuery query received from the user terminal 10 checks the syntax and converts the contents of the query to an internal format. If a query does not conform to the syntax rules, an error message to that effect is returned to the user terminal 10.

The query processing unit 22b actually processes the XQuery query converted by the query parser 22a, acquires data by making a necessary query to each database, generates an XML query result and returns the query result to the user terminal 10. That is, the query processing unit 22b generates a Structured Query Language (SQL) query to query each database, sends the SQL query generated to the databases, and acquires data related with the SQL query. The query processing unit 22b then integrates pieces of data acquired from the individual databases into XML data to be finally returned to the user terminal 10. The specific processes that are carried out by the query processing unit 22b will be described in detail later.

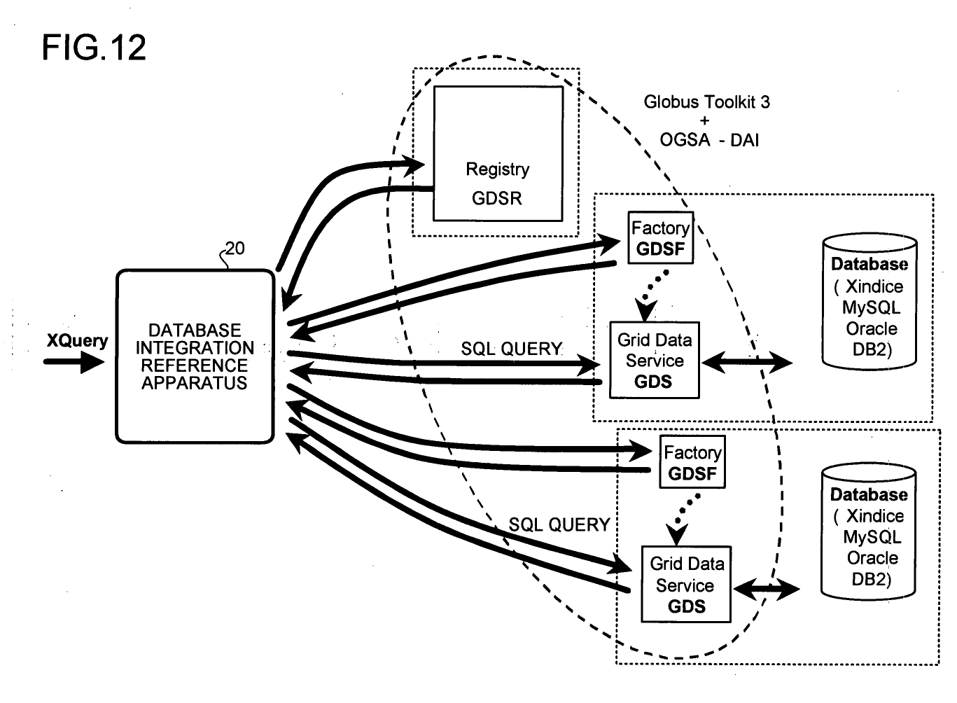

The access processing unit 22c actually accesses the databases when the query processing unit 22b makes a query with respect to the databases. Specifically, as shown in FIG. 12, the conventional query-based database integration, “Globus Toolkit 3+OGSA-DAI”, is used to access plural kinds of databases in the first embodiment.

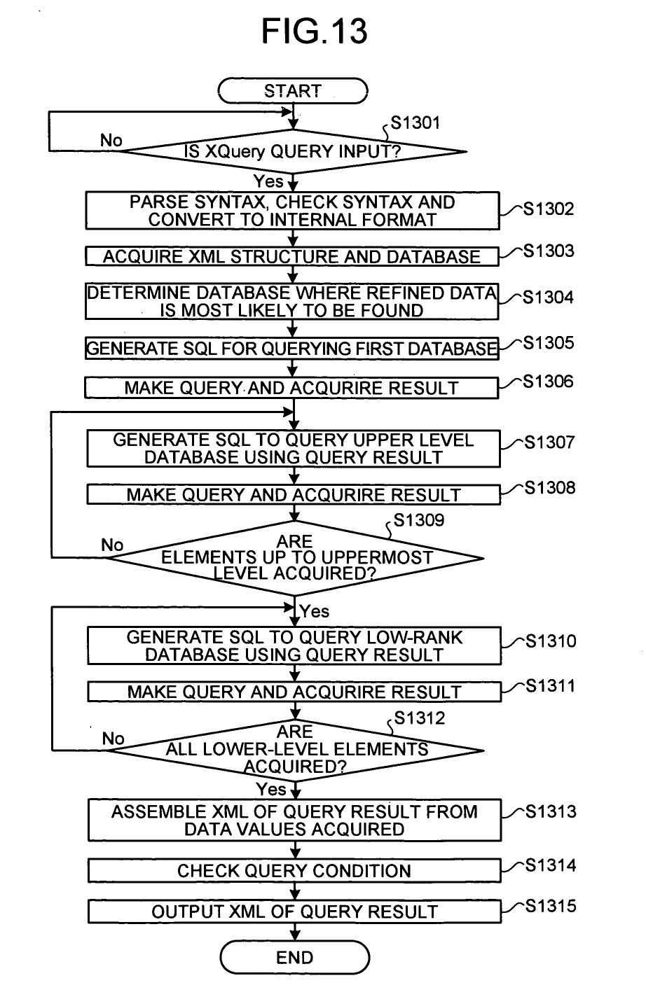

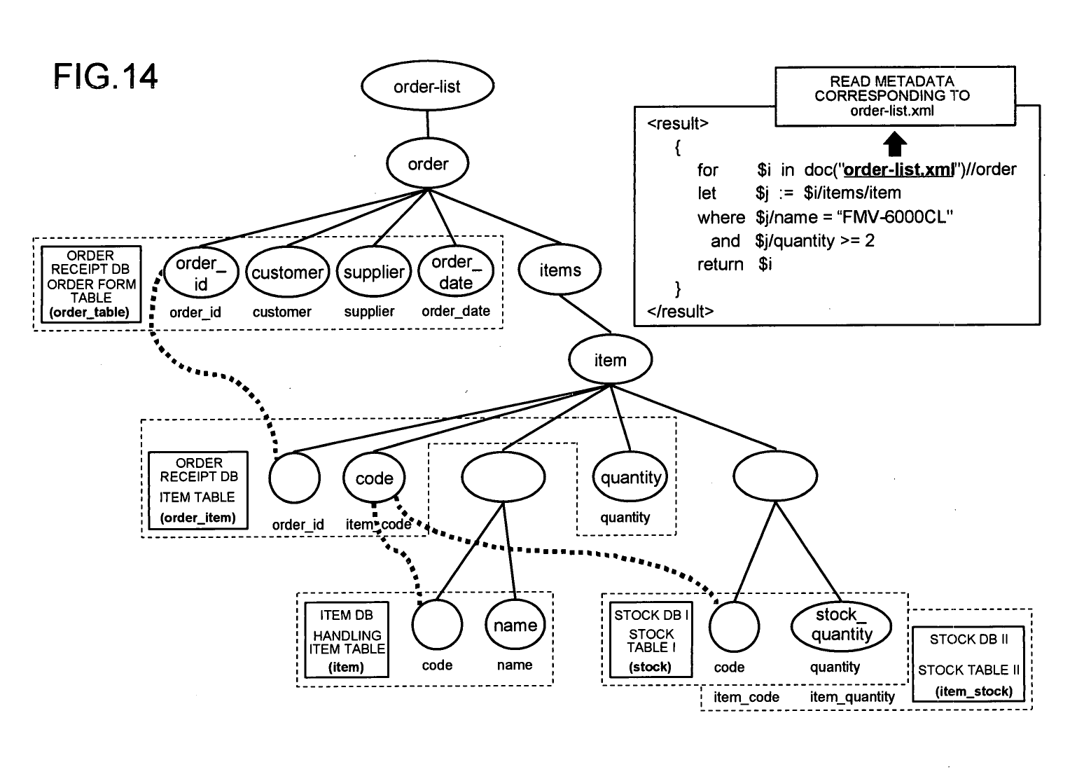

The procedures of a query process, performed by the database integration referring apparatus 20, are described next with reference to FIGS. 13 to 23. FIG. 13 is a flowchart of a query process according to the first embodiment, and FIGS. 14 to 23 are specific examples of the query process.

As shown in FIG. 13, if an XQuery query as shown in FIG. 2 is input from the user terminal 10 (YES at step S1301), the database integration referring apparatus 20 parses the syntax of the XQuery query, checks the syntax and converts the contents of the query to the internal format (step S1302). If the query does not conform to the syntax rules, an error message to that effect is sent to the user terminal 10.

Subsequently, the database integration referring apparatus 20 reads integration metadata 21 a related to the query from the memory unit 21, and obtains the structure of the XML that is the target for the query, and finds out the database in which data corresponding to each element is stored (step S1303).

Specifically, with regard to the XQuery query shown in FIG. 2, information that can be expressed by a tree structure as shown in FIG. 14 is acquired by reading integration metadata corresponding to “order-list.xml” from the memory unit 21 and then obtaining the structure of the XML and the database where data corresponding to each element is stored.

To optimize the query order, the database integration referring apparatus 20 uses the XML structure obtained at step S1303 to separate the individual elements database by database, examines the conditions in the XQuery query for each database, and determines the database where refined data is most likely to be found (step S1304).

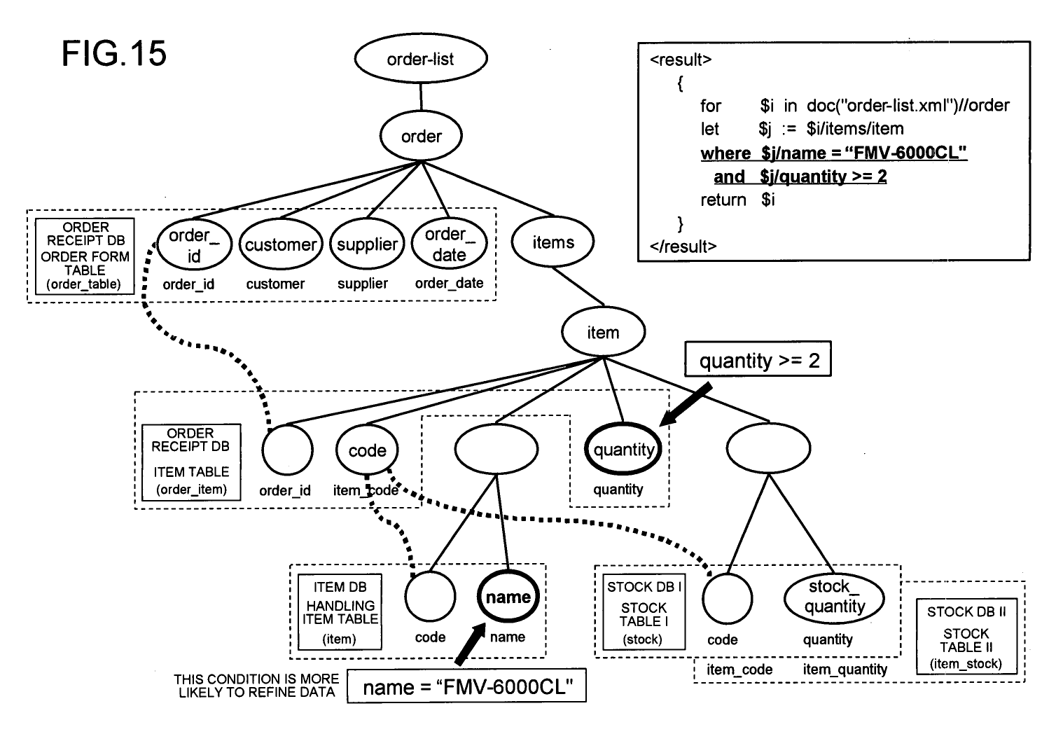

Specifically, as shown in FIG. 15, for the conditions “name=“FMV-6000CL” and “quantity>=2” included in the XQuery query, the database integration referring apparatus 20 predicts the table (item table or handling item table) to which a first query should be made, so that data contained in the result is as smaller as possible, and makes the first query to that table. FIG. 15 is an example of the first query to the handling item table. The method of optimizing the query order will be described in detail later.

Thereafter, the database integration referring apparatus 20 generates an SQL query, about data that matches with the conditions, for querying the first database determined at step S1304 (step S1305), makes the SQL query to the database and acquires a query result (step S1306). The value to be obtained from the database can just be a column related with an upper-level element.

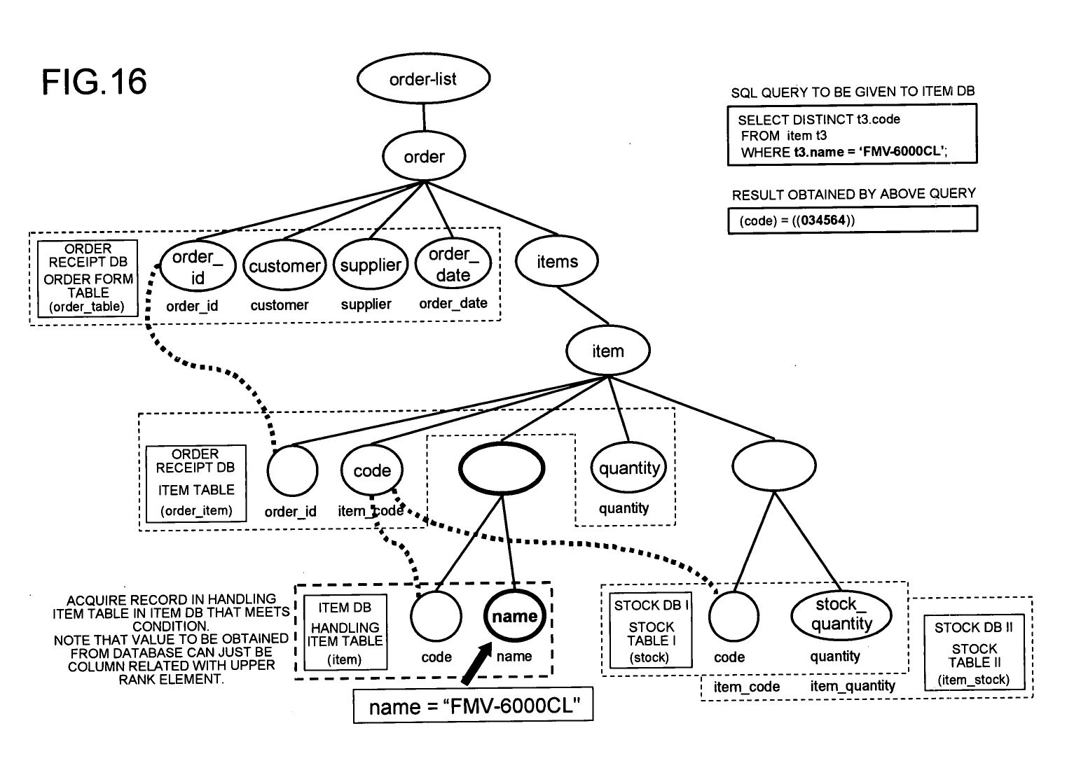

Specifically, as shown in FIG. 16, the database integration referring apparatus 20 generates an SQL query for querying the handling item table in the item DB about data which meets the condition “name=“FMV-6000CL”, and makes the query to the item DB. Thus, a query result “code=034564” is obtained from the item DB.

The database integration referring apparatus 20 repeats a process of generating an SQL query to acquire upper-level elements in the XML tree structure, giving the SQL query to the database and acquiring the query result (steps S1307 and S1308) until the uppermost element in the XML tree structure is obtained (step S1309). Thus, the data corresponding to upper elements are acquired one after another from the element for which the query to the database started.

In this process, the relation with the previous query result is used as a condition for refining data, and a condition designated by the user, if present in the XQuery query, is added as a condition for refining data. For upper and lower adjacent elements, if tables corresponding to the elements are located in the same database, a collective query is made through a single SQL query by a join process of Relational Database Management System (RDBMS). While the value to be obtained from the database may just be a column related with an upper-level element, when the uppermost element is reached, all the columns corresponding to the uppermost element are obtained.

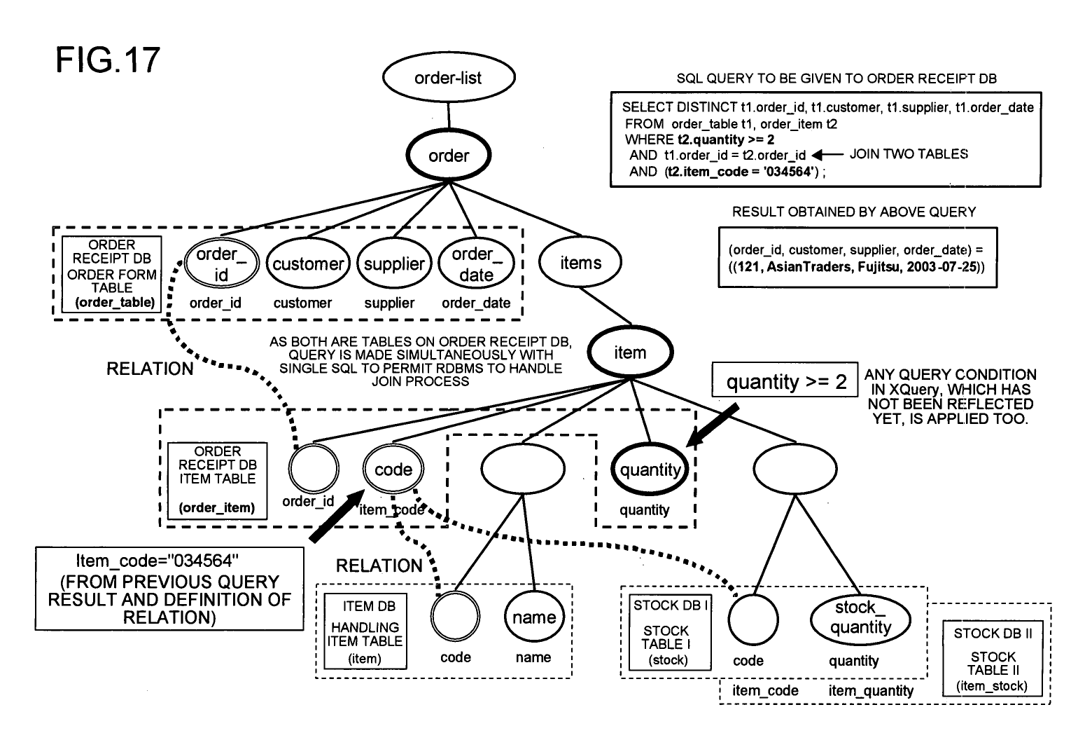

Specifically, as shown in FIG. 17, after determining to query the order receipt DB next from the relation with “code=034564”, the database integration referring apparatus 20 generates an SQL query for querying data that meets the condition “quantity>=2”, which has not been reflected yet, based on the condition “code=034564” (obtained as the previous query result) and the condition “quantity>=2” designated by the user in the XQuery query.

At the time of generating the SQL query, a single SQL query is generated, to simultaneously query both tables in the order receipt DB, with the condition that the elements in the tables have identical “order_id”. A query result “(order_id, customer, supplier, order_date)=(121, AsianTraders, Fujitsu, 2003-07-25)” is acquired from the order form table. Because the uppermost element is reached in the example shown in the diagram, all the columns corresponding to the uppermost element are obtained.

Subsequently, once the uppermost element is obtained (YES at step S1309), the database integration referring apparatus 20 repeats a process of generating an SQL query to acquire lower-level elements in order, from the uppermost element, giving the SQL query to the appropriate database, and acquiring the query result (steps S1310 and S1311) until all the elements lower than the uppermost element in the XML tree structure are acquired. Thus, the data corresponding to lower-level elements are acquired one after another (step S1312). At the time of executing the process, the result of a query for upper-level elements is designated as a data refining condition. All the columns related with the elements are obtained from the databases.

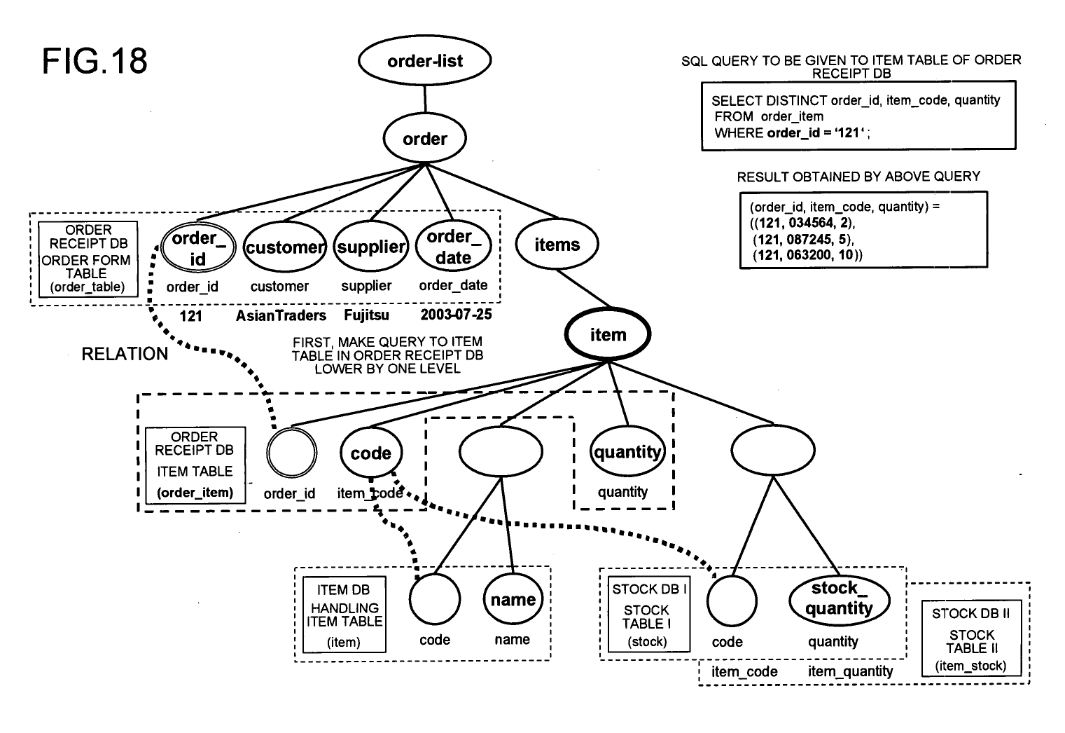

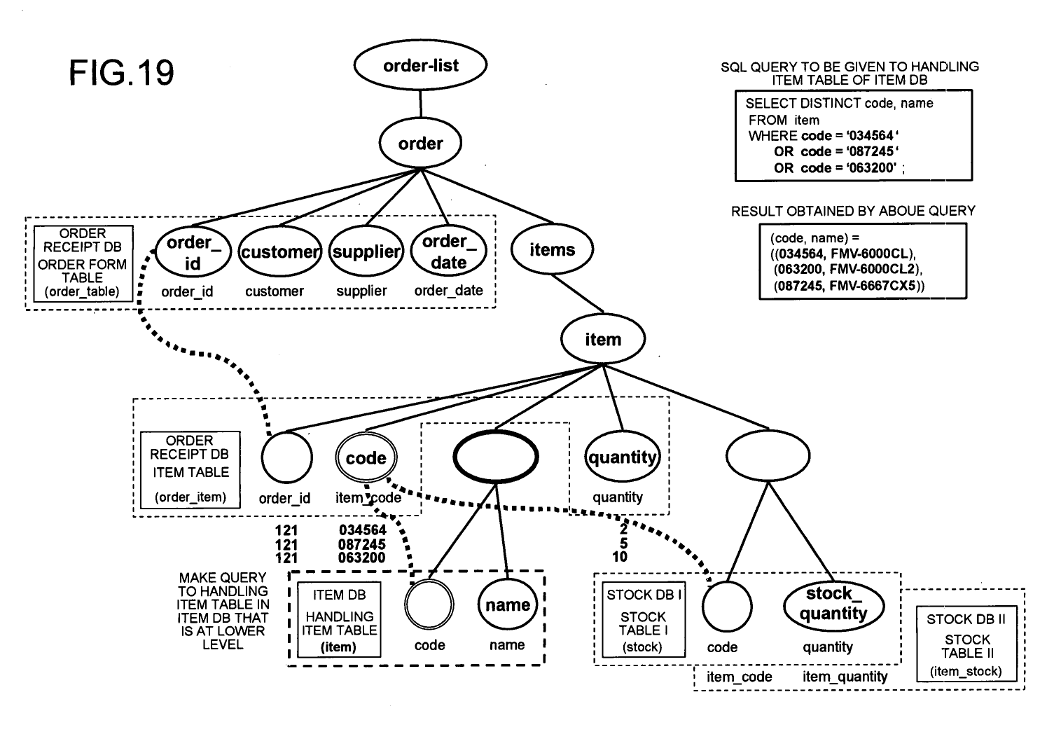

Specifically, as shown in FIG. 18, a query result “(order_id, item_code, quantity)=(121, 034564, 2), (121, 087245, 5), (121, 063200, 10)” is acquired by generating an SQL query and giving the SQL query to the item table in the order receipt DB, for data which meets the condition “order_id=121”. As shown in FIG. 19, a query result “(code, name)=(034564, FMV-6000CL), (087245, FMV-6000CL2), (063200, FMV6667CX5)” is acquired by generating an SQL query and giving the SQL query to the handling item table in the item DB, for data which meets the condition “(code=034564) or (code=087245) or (code=063200)” from the query result.

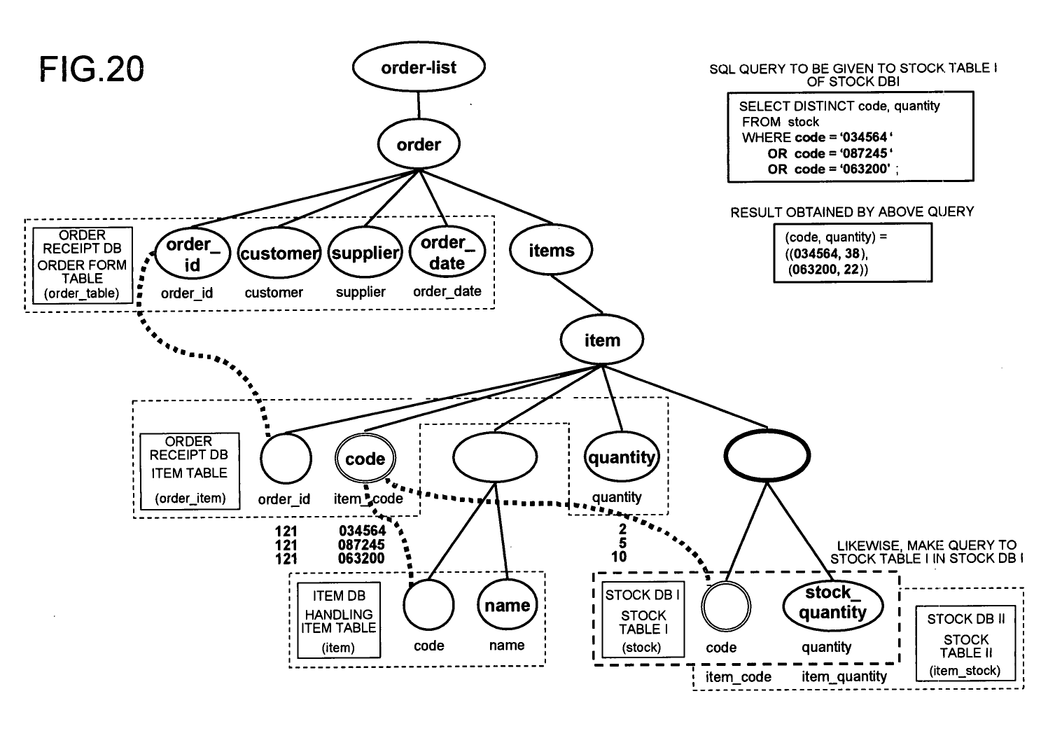

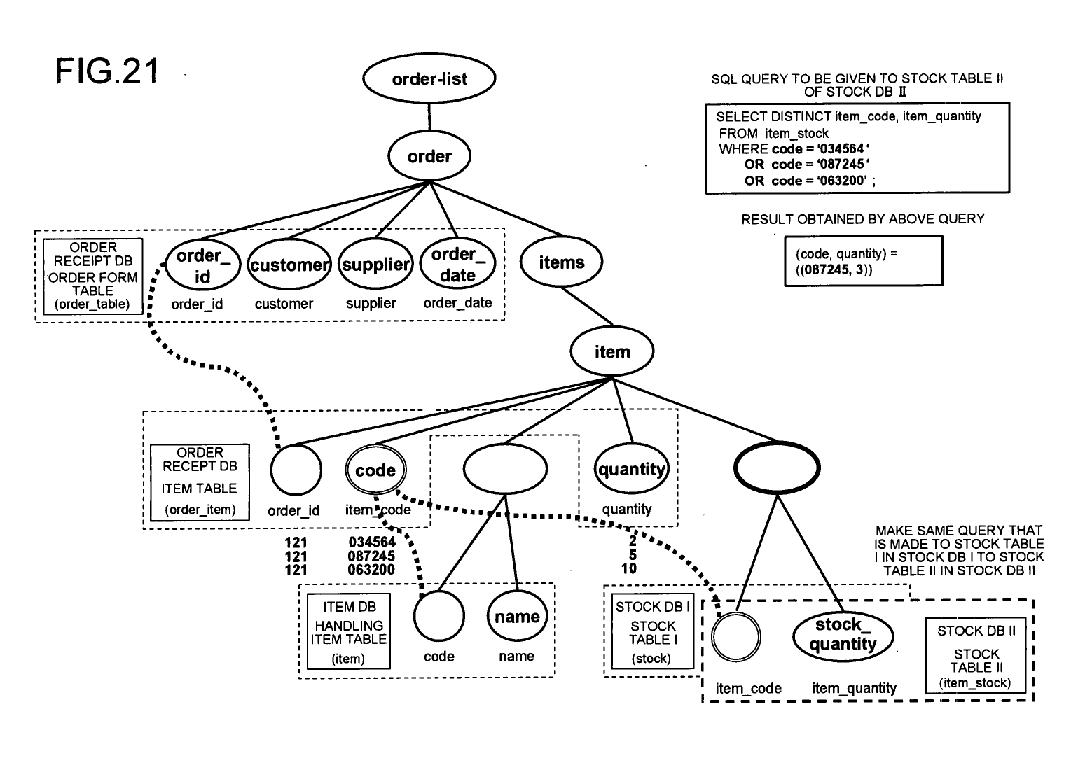

Further, as shown in FIG. 20, a query result “(code, quantity)=(034564, 38), (063200, 22)” is acquired by generating an SQL query and giving the SQL query to the stock table I in the stock DB I, for data which meets the condition “(code=034564) or (code=087245) or (code=063200)” from the query result. Likewise, as shown in FIG. 21, a query result “(item_code, item_quantity)=(087245, 3)” is acquired by generating an SQL query and giving the SQL query to the stock table II in the stock DB II, for data which meets the condition “(item_code=034564) or (item_code=087245) or (item_code=063200)”.

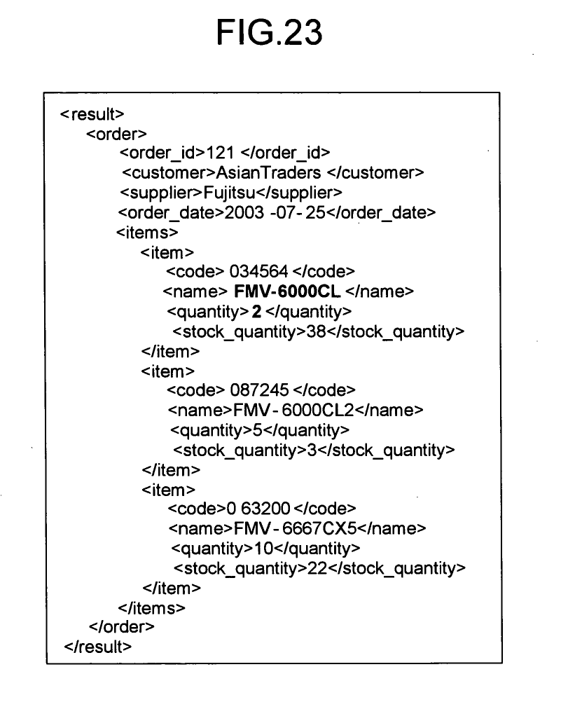

When data values of all the elements are acquired in the process (YES at step S1312), the database integration referring apparatus 20 assembles the XML of the query result from the data values acquired, while tracking the XML tree structure shown in FIG. 15, from the top (step S1313). At this point of time, if part of the query condition designated in the XQuery query has not been reflected, the database integration referring apparatus 20 assembles the final XML excluding the solution of such conditions (step S1314). Thereafter, the database integration referring apparatus 20 generates the XML of the query result as shown in FIG. 23 (step S1315).

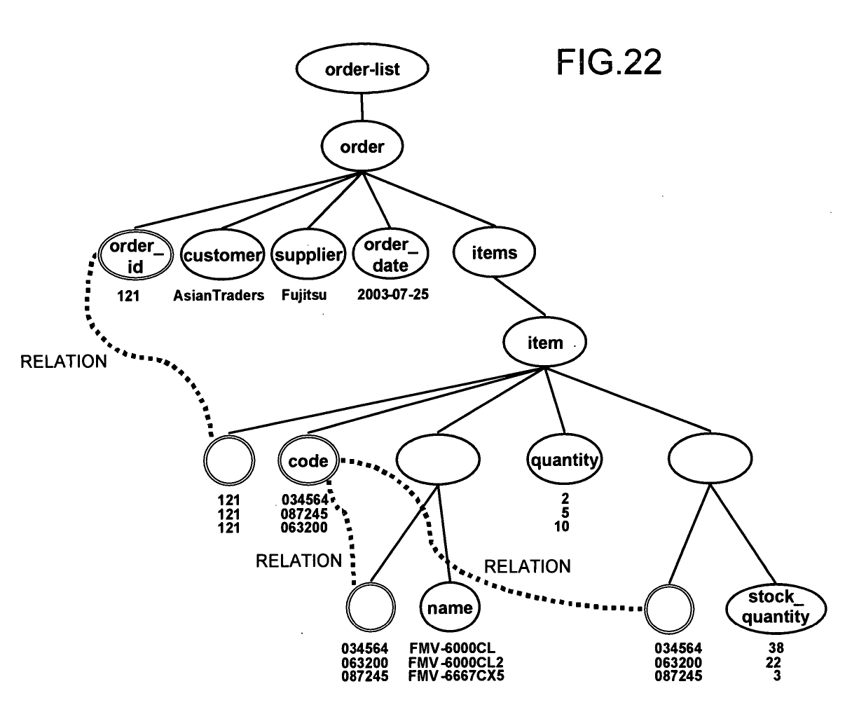

The data in XML format is returned as a query result to the user terminal 10 that has issued the XQuery query. In the steps S1307 to S1312, a query goes up to the uppermost element once, and then a query to lower-level elements is made again. This seems to be wasteful in that a query to the same database is made twice. However, the double query method is employed because, without the repetition of the query, part of XML data may be lost as given in the following example. Although only “code” with respect to “FMV-600CL” is obtained in FIG. 16, what is needed in the final result is the “code” and “name” of each of three items ordered with the “order_id” being “121” as shown in FIG. 22. Those pieces of data cannot be acquired unless “order_id” is settled as a result of acquisition of the uppermost element.

The optimization of the query order mentioned in the process related with step S1304 in FIG. 13, is described next in detail. One inherent problem of the query-based database integration is that because data is acquired over a network, the speed of data access becomes slower, and the burden on the network increases, as compared with that when data is stored locally.

When relational data is acquired sequentially from plural databases, the database integration referring apparatus 20 refines data to be acquired first based on the condition designated by a user, and refines data to be acquired thereafter based on both the relation with the previously obtained data, and the condition designated by the user. Therefore, if refining of data were insufficient, a large amount of data would be returned as a result of querying the databases. This would increase the burden on the network as well as take longer for data transfer.

As shown in FIG. 14, two conditions for refining data are written in a query from the user. The first condition is “name=“FMV-6000CL” and the second condition is “quantity>=2” (the quantity of an item ordered is equal to or greater than 2). The item name is stored in the handling item table in the item DB, and the ordered quantity is stored in the item table in the order receipt DB. This requires that the database integration referring apparatus 20 should determine the database to which an SQL query is to be made first.

If the first query results in a large amount of data, the amount of data resulting from the next query made using the first result also is large. Consequently, the amount of data gathered by the database integration referring apparatus 20 till the final query result increases, even if the final query result to be returned to the user is the same. This would not only take a longer time for data transfer but also increase the burden on the network. Therefore, the database integration referring apparatus 20 determines database to which the first query should be made, to reduce the amount of data resulting from the first query. This process is performed in consideration of the following points (1) to (4), after acquisition of metadata of each database (metadata of each database is different from integration metadata).

(1) Limiting Condition on Data Redundancy

By referring to metadata of a database, it is checked if a column conditioned in an XQuery query becomes a main key in the table or a unique limitation is set. If either condition is fulfilled, the column does not have data redundancy, making higher the possibility that data can be refined.

(2) Number of Pieces of Data

By referring to metadata of a database, it is checked if the table contains a large number of records. If the table contains a large number of records, the number of records that would return as a result of a query, is likely to be large.

(3) Type of Data and Number of Digits

By referring to metadata of a database, it is checked if the data in a column is of a type short in length or having a fewer number of digits, such as a numeral or a Boolean value. In this case, the amount of redundant data in the column is likely to be large. Therefore, a larger number of records is likely to be returned as a result of a query.

(4) Type of Condition Designated by User

It is checked if a conditional equation in an XQuery query is designated by an equal sign or a sign of inequality. A conditional equation designated by an equal sign is more likely to refine data as compared with when the conditional equation is designated by a sign of inequality.

The database integration referring apparatus 20 checks if the four conditions are met, marks a point for each query condition fulfilled, and starts a query from the database whose condition has the highest points. FIG. 15 is an example where it is determined that it is likely to be able to refine data if a query about the condition “name=“FMV-6000CL”” is made to the handling item table.

After the database to which querying is to be started is determined by the optimization method, upper-level elements are obtained one after another toward the uppermost element of the XML tree using the relation information. Alternatively, simultaneous SQL queries may be made to databases corresponding to other query conditions in the XQuery query and joining the results. In this case, it is likely that the amount of resultant data that is returned from each database is large. Therefore, this embodiment does not employ the alternative method.

According to the first embodiment, the user need not be aware of the storage structure or the location of data. Therefore, the user can handle plural databases as if they were a single database.

Moreover, the user need not explicitly search for data in plural databases, and can make a query without being aware of dispersion of data.

Furthermore, manipulating the query sequence refines the result of the query input by the user, and the amount of data transfer is reduced. Consequently, query processing time and the burden on a network reduce.

Moreover, the entire tagged document can be acquired thoroughly, irrespective of the structural definition of the tagged document or the contents of the query, and the number of queries to the databases reduces.

The present invention is not limited to the first embodiment, but may be worked out in various different forms within the range of the technical concept described in the appended claims. Various examples, are explained below in six separate subjects: (1) tagged document, (2) database, (3) integration metadata, (4) accessing process, (5) system structure or the like, and (6) program.

(1) Tagged Document

In the first embodiment, XML is used as a tagged document. However, the present invention is not limited thereto, but other types of tagged documents, such as Standard Generalized Markup Language (SGML), may be used.

In the first embodiment, “XQuery”, a query language that is undergoing standardization at W3C at present, is used for a query to XML. However, the present invention is not limited thereto, but may use other query languages, such as XPath.

(2) Database

The first embodiment considers integration of relational databases. However, the present invention is not limited thereto, but may similarly be adapted when databases of other types are integrated.

(3) Integration Metadata

In the first embodiment, a single piece of integration metadata is prepared. However, the present invention is not limited thereto, and plural integration metadata data may be prepared based on the method of database integration. For example, plural integration metadata may be prepared based on the mode of outputting the query result.

(4) Accessing Process

In the first embodiment, Globus Toolkit 3+OGSA-DAI is used to access plural types of databases. However, the present invention is not limited thereto, and the databases may be accessed in any way, regardless of the method of querying.

(5) System Structure or the Like

The individual structural components of each apparatus or unit shown in the diagrams, and particularly, the database integration referring apparatus 20, are shown in the form of conceptual functional units and should not necessarily be constructed physically as shown. That is, specific modes of dispersion and integration of the individual apparatuses or units are not restricted to those shown above, and all or some of them can be functionally or physically dispersed or integrated in arbitrary units based on various loads or use conditions. Further, all or any part of the individual processing functions that are executed by the individual apparatuses or units can be achieved by a central processing unit (CPU) and a program that is executed by the CPU, or can be achieved as wired-logic hardware.

All or some of the processes in the first embodiment that are described as being automatically executed can be performed manually, or all or some of the processes that are described as being manually executed can be performed automatically by a known method. In addition, the process procedures, control procedures, specific names, and information including various kinds of data and parameters, which are shown in the foregoing description and the accompanying drawings, can be modified arbitrarily unless otherwise specified.

(6) Program

Individual processes that are described in the foregoing description of the first embodiment can be accomplished as a computer system, such as a personal computer or a workstation, by running a previously prepared program. As a second embodiment, a computer system that runs a program with functions similar to those of the first embodiment is discussed below.

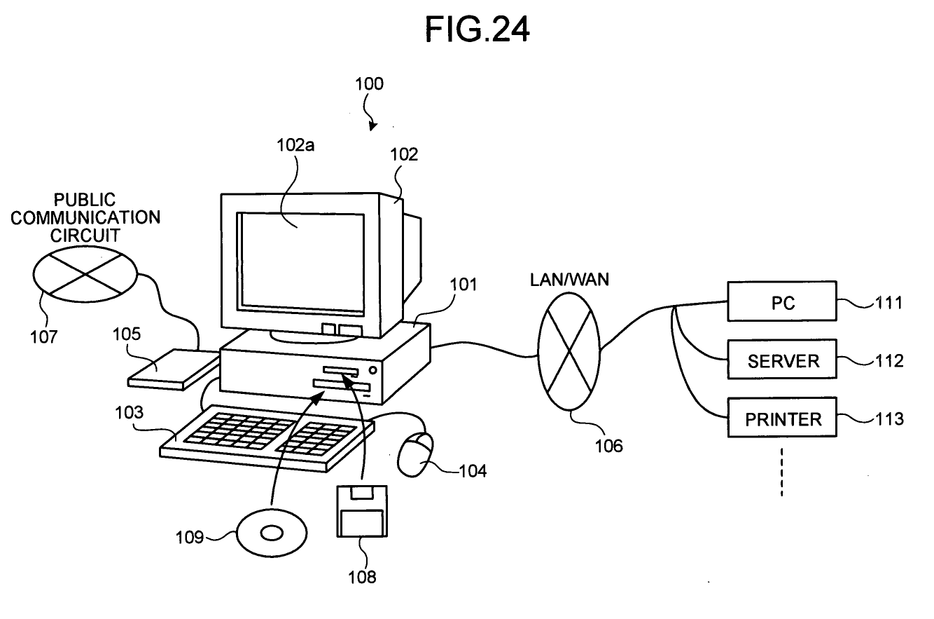

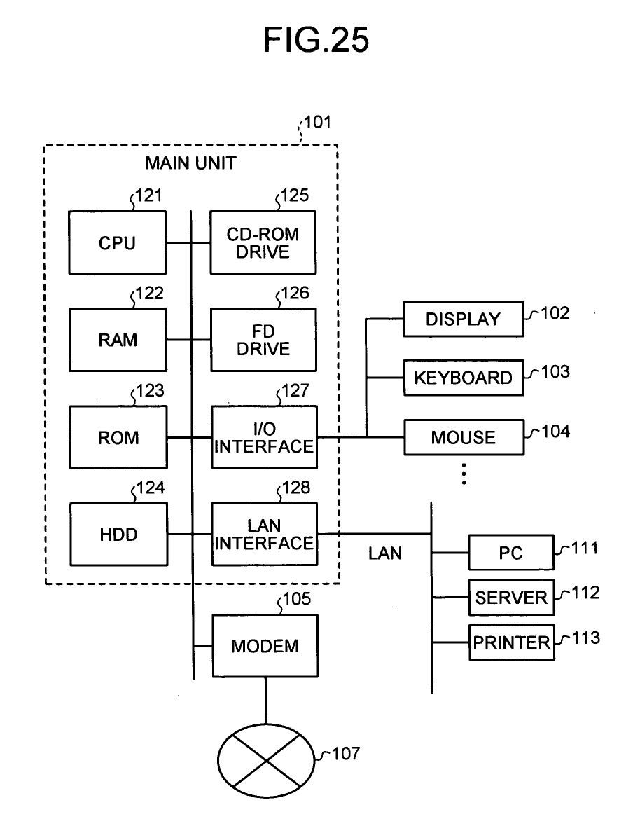

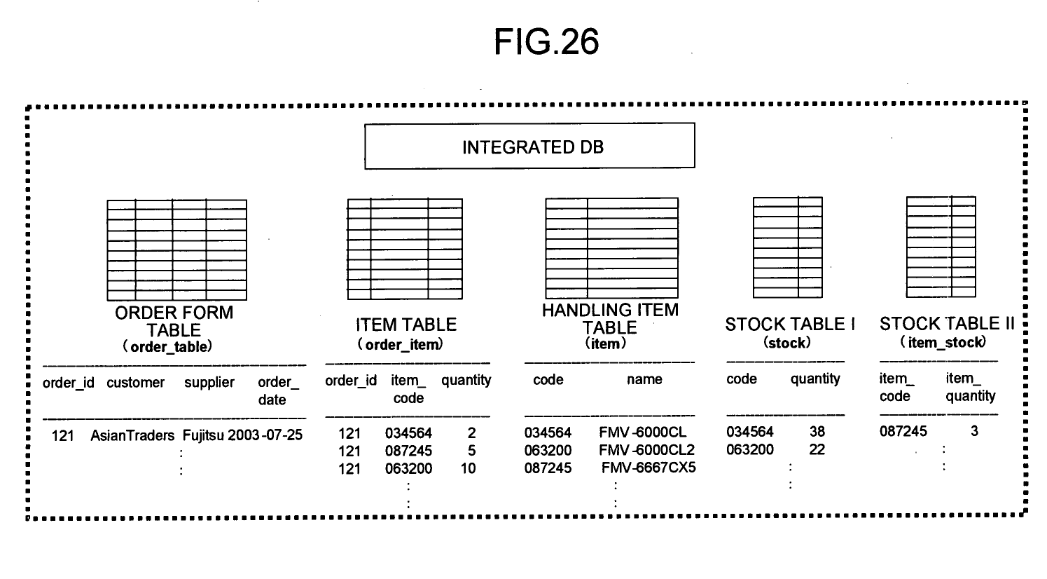

FIG. 24 illustrates a computer system according to a second embodiment, and FIG. 25 is a block diagram of a main unit of the computer system. The computer system 100 has a main unit 101, a display 102 that displays information such as an image on a display screen 102a in response to an instruction from the main unit 101, a keyboard 103 through which various kinds of information is input to the computer system 100, and a mouse 104 that specifies an arbitrary position on the display screen 102a of the display 102.

The main unit 101 of the computer system 100 includes a CPU 121, a random access memory (RAM) 122, a read only memory (ROM) 123, a hard disk drive (HDD) 124, a CD-ROM drive 125 that accesses a CD-ROM 109, a floppy disk (FD) drive 126 that accesses a flexible disk 108, an I/O interface 127 that connects the display 102, the keyboard 103 and the mouse 104 together, and a LAN interface 128 which connects to a local area network or a wide area network (LAN/WAN) 106.

The computer system 100 is connected to a public communication circuit 107 such as the Internet through a modem 105, and is further connected with another personal computer system (PC) 111, a server 112, a printer 113, etc. via the LAN interface 128 and the LAN/WAN 106.

The computer system 100 reads and runs a program recorded on a predetermined recording medium, and achieves functions similar to those of the first embodiment. The predetermined recording medium includes every kind of recording medium that records a program readable by the computer system 100, such as a “fixed physical medium” like the HDD 124, the RAM 122 or the ROM 123, a “communication medium” that holds a program for a short period of time at the time of transmitting the program, and a “portable physical medium”. The “communication medium” includes the public communication circuit 107 connected via the modem 105 or the LAN/WAN 106 to which another computer system 111 and the server 112 are connected. The “portable physical medium” includes the FD 108, the CD-ROM 109, an magneto-optical (MO) disk, a digital versatile disk (DVD), a magnetic-optical disk or an IC card.

In other words, the program is recorded in a recording medium, such as the “portable physical medium”, the “fixed physical medium” or the “communication medium”, in a computer readable manner. The computer system 100 achieves functions similar to those of the first embodiment by reading out the program from such a recording medium and running the program. Moreover, the program is not limited to the one that is run by the computer system 100, but the present invention can similarly be adapted when another computer system 111 or the server 112 runs the program or when the computer systems and the server 112 cooperate to run the program.

According to the present invention, the user need not be aware of the storage structure or the location of data. That is, the user can make a query without being aware of dispersion of data.

Moreover, manipulating the query sequence refines the result of the query input by the user, and the amount of data transfer is reduced. Consequently, query processing time and the burden on a network reduce.

Furthermore, the result of a query can be acquired in the form of an entire tagged document without loss of data, and the number of queries to databases reduces, regardless of how the structure of the tagged document is defined or the contents of each query.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

1. An apparatus for referring to database integration, comprising:
a storing unit that stores integration metadata which defines a format of a tagged document used for outputting a result of a query for data reference to a plurality of databases, a relation between each element in the tagged document and each element in each database, and a relation between the elements in each database; and
a query processing unit that receives the query in a format of the tagged document, refers to the integration metadata in the storing unit and makes a query with respect to various databases to acquire data, and generates a result of the query in the format of the tagged document.

2. The apparatus according to claim 1, wherein the query processing unit determines a first database among the plurality of databases, such that a result of a first query, made using contents of the query and metadata related to the databases, yields a most refined result, and makes the first query with respect to the first database.

3. The apparatus according to claim 2, wherein the query processing unit makes the query based on a tree structure of the tagged document defined in the integration metadata, in such a way that after acquiring the result of the first query related with a first element, the query processing unit makes a query to acquire data by following upper-level elements in order from the first element till an uppermost element in the tree structure, and then makes a query to acquire data by following all elements lower than the uppermost element.

4. A method of referring to database integration, comprising:
storing integration metadata, in which a format of a tagged document used for outputting a result of a query for data reference to a plurality of databases, a relation between each element in the tagged document and each element in each database, and a relation between the elements in each database are defined; and
performing query processing that includes receiving the query in a format of the tagged document, referring to the integration metadata and making a query with respect to various databases to acquire data, and generating a result of the query in the format of the tagged document.

5. A computer program that makes a computer execute:
storing integration metadata, in which a format of a tagged document used for outputting a result of a query for data reference to a plurality of databases, a relation between each element in the tagged document and each element in each database, and a relation between the elements in each database are defined; and
performing a query processing that includes receiving the query in a format of the tagged document, referring to the integration metadata and making a query with respect to various databases to acquire data, and generating a result of the query in the format of the tagged document.
